(19) United States
(12) Patent Application Publication
(10) Pub. No.: US 2026/0172630 A1
(43) Pub. Date: Jun. 18, 2026

(54) INFORMATION PROCESSING DEVICE, METHOD, AND PROGRAM

(71) Applicant: Sony Group Corporation, Tokyo (JP)

(72) Inventor: Hisako SUGANO, Kanagawa (JP)

(73) Assignee: Sony Group Corporation, Tokyo (JP)

(21) Appl. No.: 18/853,722

(22) PCT Filed: Apr. 13, 2023
(86) PCT No.: PCT/JP2023/014959

§ 371 Date: Oct. 3, 2024

(30) Foreign Application Priority Data
Apr. 28, 2022 (JP) 2022-074120

(51) Int. Cl. H04N 21/45; H04N 21/2187; H04R 3/00

(52) U.S. Cl. CPC H04N 21/4532; H04N 21/2187; H04R 3/005

(57) ABSTRACT

There is provided an information processing device, method, and a program enabling a part of a music piece that each performer is in charge of to be easily recognized. The information processing device includes: a video generation unit that generates, on the basis of text information including text of sound from a plurality of sound sources and one or a plurality of videos including the at least one sound source as an object, a presentation video in which with a color representing the sound source of sound that is being emitted, a part of the text corresponding to the sound that is being emitted, a figure, or a character sequence representing the sound source is displayed. The present technology can be applied to a video processing system.

### TECHNICAL FIELD

The present technology relates to an information processing device and method, and a program, and more particularly to an information processing device and method, and a program enabling each performer to easily recognize a part of a music piece that the performer is in charge of.

### BACKGROUND ART

In live concert venues, for example, a video performance such as display of computer graphics (CG) videos prepared in advance on display devices called light emitting diode (LED) visions or LED monitors and display of videos captured by cameras that are capturing a video in real time in the live concert venue on an LED vision is performed.

Moreover, a video performance such as display of videos called embedded videos obtained by synthesizing CG videos prepared in advance with videos of cameras that are capturing a video in real time on LED visions and display of lyrics of music pieces in a superimposed manner on each of videos as described above on LED visions is also performed. Furthermore, there have been cases where such videos are live-streamed in recent years.

Such videos displayed in live concert venues are generated in places called video boards. The video boards are places where all video signals are aggregated in the live concert venues such as video master control rooms (main tuning rooms).

A plurality of video serves, switchers, routes, and the like are disposed in a video board, and an operator at the video board selects video signals to be output.

In an example, camera videos captured by about ten camera operators arranged in a live concert venue are aggregated in a router of a video board, and a video (final video) that is to be finally presented is generated by appropriately performing effect processing and CG synthesis on the camera videos. Then, the final video is displayed on an LED vision installed in the live concert venue. Note that processing of superimposing lyrics of a music piece on the final video or the like is also performed on the video board.

In the current situation, video signal control that is performed by the video board to generate and output the final video is realized by an operator performing switching operations and the like in accordance with musical divisions.

Musical divisions denote which member is to sing and which lyric part the member is to sing for each bar of a music piece in a case where a plurality of members (performers) sing the music piece. In other words, the musical divisions are information indicating parts that each member (performer) is in charge of in the music piece.

Musical division notation rules are different for each artist, and lyrics of music pieces may be shown in musical divisions, parts (harmony parts) of lyrics to be sung by all members may be underlined, or names of persons who are in charge of (members who are to sing) corresponding parts of lyrics may be shown, for example.

Meetings and progress decisions for a live performance are carried out on the basis of such musical divisions. Specifically, timings of switching camera switches, turning-on of illuminations, activating of special effects, and the like during a live concert, for example, are determined on the basis of the musical divisions.

As described above, an operator (video creation staff member) manually performs video signal control on a video board in accordance with the musical divisions. Similarly, camera operators inside of a live concert venue also perform camera operations in response to voice instructions from other staff members who refer to the musical divisions.

Therefore, it is possible to reduce occurrence of errors in operations and errors in image capturing by allowing the operator, the camera operators, and the like to be able to recognize parts that each performer (member) is in charge of in a music piece clearly at a glance.

Also, it is possible for an audience and the like to instantaneously recognize which performer is singing and which part of a music piece the performer is singing and to better enjoy a live concert by allowing them to ascertain parts of the music piece that each performer is in charge of clearly at a glance in a case where lyrics are displayed in a superimposed manner on a performance video to be presented to the audience of the live concert.

For example, an accompaniment replay display device that presents characters of lyric information in different colors in accordance with pitches of a music piece has been proposed as a technology regarding presentation of lyrics of a music piece (see PTL 1, for example).

In addition, a technology of causing lyrics captions to be displayed in synchronization with a music piece by comparing a live video generated in real time with a background video of the performance of performers, for example, has also been proposed (see PTL 2, for example).

### CITATION LIST

### Patent Literature

PTL 1: JP 2647890 B
PTL 2: JP 2008-145978 A

### SUMMARY

### Technical Problem

However, according to the aforementioned technologies, it is difficult to easily recognize parts of a music piece that each performer is in charge of.

Although it is possible to present lyrics information such that pitches of a music piece can be instantaneously recognized by the technology described in PTL 1, for example, singing the music piece by a plurality of performers is not taken into consideration, and it is not possible to perform display regarding parts that each performer is in charge of.

Similarly, since singing a music piece by a plurality of performers is not taken into consideration in the technology described in PTL 2 as well, it is not possible to perform display regarding parts that each performer is in charge of.

The present technology was made in view of such circumstances and is adapted to enable parts of a music piece that each performer is in charge of to be easily recognized.

### Solution to Problem

An information processing device according to a first aspect of the present technology includes: a video generation unit that generates, on the basis of text information including text of sound from a plurality of sound sources and one or a plurality of videos including the at least one sound source as an object, a presentation video in which with a color representing the sound source of sound that is being emitted, a part of the text corresponding to the sound that is being emitted, a figure, or a character sequence representing the sound source is displayed.

An information processing method or a program according to the first aspect of the present technology includes: generating, on the basis of text information including text of sound from a plurality of sound sources and one or a plurality of videos including the at least one sound source as an object, a presentation video in which with a color representing the sound source of sound that is being emitted, a part of the text corresponding to the sound that is being emitted, a figure, or a character sequence representing the sound source is displayed.

In the first aspect of the present technology, the presentation video is generated in which the part corresponding to the sound that is being emitted, the figure, or the character sequence representing the sound source is displayed with the color representing the sound source of the sound that is being emitted on the basis of the text information including the text of the sound from the plurality of sound sources and the one or plurality of videos including the at least one sound source as an object.

An information processing device according to a second aspect of the present technology includes: a color processing unit that generates, on the basis of audio data including sound from a plurality of sound sources, or metadata of the audio data, and text information including text of the sound from the plurality of sound sources prepared in advance in regard to the audio data, colored text information in which a different color for each of the sound sources is added to the text of the sound from each of the plurality of sound sources.

An information processing method or a program according to the second aspect of the present technology includes: generating, on the basis of audio data including sound from a plurality of sound sources, or metadata of the audio data, and text information including text of the sound from the plurality of sound sources prepared in advance in regard to the audio data, colored text information in which a different color for each of the sound sources is added to the text of the sound from each of the plurality of sound sources.

In the second aspect of the present technology, the colored text information in which the different color for each of the sound sources is added to the text of the sound from each of the plurality of sound sources is generated on the basis of the audio data including the sound from the plurality of sound sources, or the metadata of the audio data, and the text information including the text of the sound from the plurality of sound sources prepared in advance for the audio data.

### BRIEF DESCRIPTION OF DRAWINGS

FIG. 1 is a diagram for explaining the present technology.

FIG. 2 is a diagram illustrating an example of colored musical division data.

FIG. 3 is a diagram illustrating a configuration example of an information processing device.

FIG. 4 is a diagram illustrating an example of metadata.

FIG. 5 is a flowchart for explaining colored musical division data generation processing.

FIG. 6 is a diagram illustrating a configuration example of a video processing system.

FIG. 7 is a flowchart for explaining display processing.

FIG. 8 is a diagram illustrating a configuration example of a synthesized video generation device.

FIG. 9 is a flowchart for explaining synthesized video generation processing.

FIG. 10 is a diagram illustrating a display example of a camera video and a score.

FIG. 11 is a diagram illustrating an example of a return video.

FIG. 12 is a diagram illustrating an example of a synthesized video.

FIG. 13 is a diagram illustrating an example of a synthesized video.

FIG. 14 is a diagram illustrating an example of a synthesized video.

FIG. 15 is a diagram illustrating a configuration example of a computer.

### DESCRIPTION OF EMBODIMENTS

Hereinafter, embodiments to which the present technology is applied will be described with reference to the drawings.

### First Embodiment

### Present Technology

The present technology is for enabling parts of a music piece that each performer is in charge of to be easily recognized by adding color information corresponding to the performer who is in charge of the parts to the parts of lyrics of the music piece.

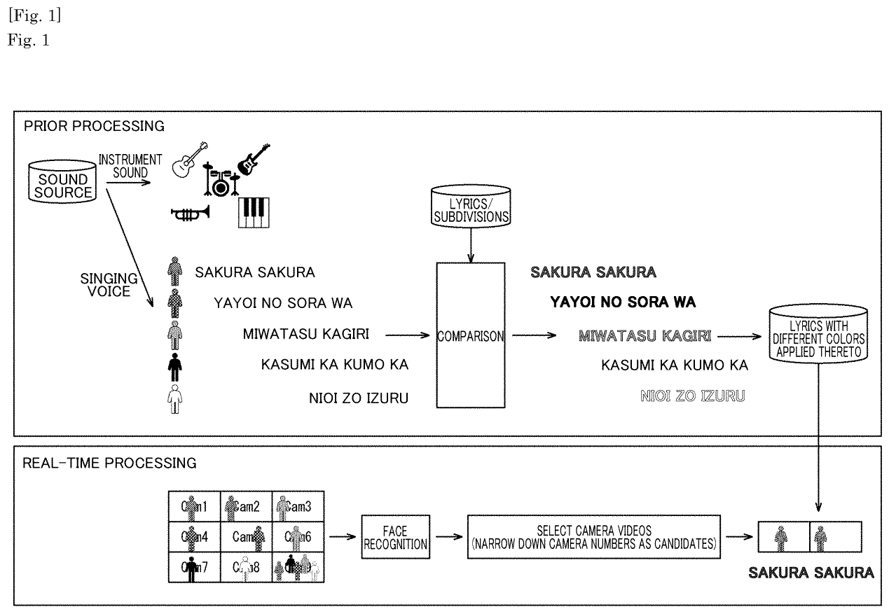

First, an overview of the present technology will be described with reference to FIG. 1. Note that a case where the present technology is applied to live performance will be described below as a specific example.

In the example in FIG. 1, prior processing and real-time processing are performed to perform a video performance in an actual live concert. The prior processing is processing performed in advance before the live concert, and the real-time processing is processing that is performed during the live concert using results of the prior processing.

In the prior processing, sound source separation processing is performed on previously prepared sound sources of a music piece to be performed in the live concert, that is, audio data of the music piece as needed, and the audio data of the entire music piece is separated into audio data for instrument sound and audio data for singing voices.

Note that audio data for replaying the instrument sound in the music piece, more specifically sound other than the singing voice of the performers will also be referred to as instrument sound data while audio data for replaying only the singing voice of the performers will also be referred to as singing voice data below. In a case where singing voice data is available in advance, the sound source separation processing is not needed.

It is possible to specify, from the singing voice data, which performer from among a plurality of performers (members) is singing each section, that is, which performer is in charge of the section for each section of the music piece.

Next, the singing voice data of the music piece and lyrics information of the music piece prepared in advance, more specifically, musical division data are compared.

The musical division data is data including the lyrics information of the music piece and information indicating a performer who is in charge of each part of the lyrics of the music piece. In other words, the musical division data is text information including information indicating text of sound from each of a plurality of sound sources replayed on the basis of the singing voice data, that is, text of the lyrics of the music piece sung by the plurality of performers and the sound sources (performers who are singing each lyrics part) emitting sound at each part of the text.

Color information corresponding to the performers who are in charge of each part of the lyrics of the music piece is added on the basis of the result of comparing the singing voice data with the musical division data, and lyrics information with different colors applied thereto for each of performers who is in charge is obtained. Here, colored musical division data is obtained as lyrics information with different colors applied thereto.

Although the colors corresponding to the performers, that is, the colors representing the performers may be defined in any manner, it is possible to enable parts of the music piece that each performer is in charge of to be more easily recognized if member colors of the performers (members) are assigned.

In general, member colors are often determined for group artists in order to identify the individual members, and for example, costumes, microphones, and earphones, for example are colored for the members to prevent mistakes. Also, fans send messages to members (artists) by blinking LED lights of colors of the members whom the fans support during the live concert.

Therefore, it is possible for not only staff members such as operators and camera operators but also live concert audience, viewers of live streaming, and the like to instantaneously recognize performers corresponding to member colors by allocating the member colors of the performers to each of the plurality of performers (members).

The colored musical division data is obtained through the prior processing as described above. The colored musical division data includes the lyrics information of the music piece, the information indicating the performers who are in charge of each part of the lyrics of the music piece, and the color information indicating, for each part of the lyrics of the music piece, the performers who are in charge of the part.

In other words, it is possible to state that the colored musical division data is colored text information in which a different color for each sound source (performer) is applied to each part of text information of sound from the plurality of sound sources based on the audio data, which is singing voice (voice) of the plurality of performers, that is, each part of the lyrics.

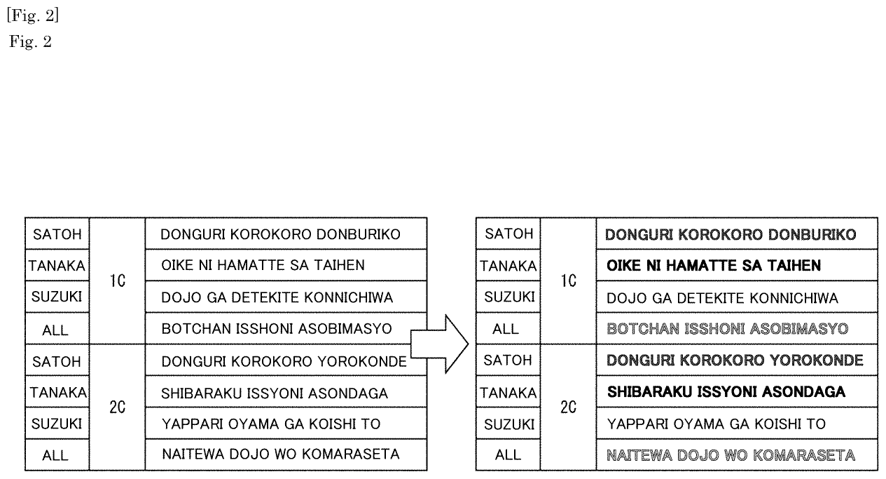

Here, a specific example of the colored musical division data is illustrated in FIG. 2.

FIG. 2 illustrates an example of musical division data of one music piece before color information is added on the left side in the drawing and illustrates an example of colored musical division data obtained by adding color information to the musical division data on the right side in the drawing.

In the musical division data illustrated on the left side in the drawing, names of performers are shown on the left-side sections in the musical division of the music piece, what numbers of chorus parts the lyrics information corresponds to is shown in the center sections, and in the right-side sections, the lyrics of the music piece is sectioned for each bar and is shown in black characters, that is, characters of a single color.

In this example, the music piece is sung by a group (three-person group) of three performers, namely Satoh, Tanaka, and Suzuki.

In the musical divisions, the name of the performer shown on the left side of the lyrics for each shown section (bar) indicates the performer who is in charge of the part of the lyrics.

Specifically, “donguri korokoro donburiko” which is a starting part of the music piece shown at the top of the musical divisions, for example, is a part that the performer Satoh is in charge of. Also, the parts of the music piece where there are descriptions “all members” in the sections for the names of performers indicate that all the three performers are to sing (in charge).

Here, it is assumed that member colors of the performers “Satoh”, “Tanaka”, and “Suzuki” are “green”, “blue”, and “orange”, respectively.

In such a case, the colored musical division data illustrated on the right side in the drawing is obtained from the musical division data illustrated on the left side in the drawing and the member colors of the performers.

The configuration of the musical divisions indicated by the colored musical division data, that is, the arrangement of the described sections for the lyrics of the music piece and the described sections for the names of the performers (the names of the members) who are in charge of each part is the same as that in the case of the musical division data illustrated on the left side in the drawing.

A difference between the musical division data and the colored musical division data illustrated in FIG. 2 is that the lyrics of the music piece is described by characters of the same color (single color) regardless of the performers who are in charge in the musical division data while the lyrics of the music piece are shown in characters of the member colors of the performers who are in charge in the colored musical division data.

For example, since the performer “Satoh” is in charge of the starting part “donguri korokoro donburiko” of the music piece described at the top of the musical divisions indicated by the colored musical division data, the lyrics of the starting part are shown in characters in a green color that is a member color of the performer “Satoh”.

Also, the lyrics of the parts that all the performers are in charge of at the same time, for which there are descriptions “all members” in the sections for the names of the performers, is described by characters of a color that is different from any of the member colors of the performers.

According to such colored musical division data with color information added thereto, it is possible to instantaneously and intuitively recognize which performer is in charge and which part of the music piece the performer is in charge of.

For example, not only staff members such as operators and camera operators but also artists (performers) may use the colored musical division data, and who is to sing and which part of the music piece the performer is to sing can be recognized clearly at a glance for each performer in such a case as well.

Returning to explanation of FIG. 1, once the colored musical division data is obtained through the prior processing, real-time processing is then performed on the basis of the colored musical division data during the live concert.

In the real-time processing, image capturing is performed by a plurality of cameras in the live concert venue, and face recognition processing is performed on a plurality of camera videos obtained as a result.

Since it is possible to specify which performer (member) appears as an object in the camera videos through the face recognition processing, candidates for camera videos to be used to generate a video for performance (presentation) are selected from results of the face recognition processing, the colored musical division data, and the like. In other words, one or a plurality of camera videos are selected as candidates for camera videos to be used to generate a video for performance from among the plurality of camera videos obtained through the image capturing.

In this case, a camera video including a performer (member) who is in charge of a part of the music piece that is being currently performed, for example, as an object may be selected as a candidate.

An operator or the like appropriately performs final selection from the thus obtained candidates, a synthesized video which is a video for performance is generated on the basis of the one or plurality of finally selected camera videos and the colored musical division data, and the obtained synthesized video is presented in the live concert venue.

For generating the synthesized video, for example, some or all of the plurality of camera videos, CG videos prepared in advance, and the like are aligned and synthesized, and lyrics at a part of the music piece that is being performed is synthesized with (superimposed on) the synthesized video with a member color of the performer who is in charge of the part.

At this time, video creation staff members such as an operator can perform operations such as switching operations, turning on lighting, activation of special effects, and the like while referring to the colored musical division data and referring to the candidates (camera videos) selected and presented on the basis of the colored musical division data.

Therefore, it is possible to reduce occurrence of mistakes of the video creation staff members in camera switching timings, special effect activation timings, and the like.

Moreover, a video generated on the basis of the colored musical division data such that which performer (member) is in charge of a part of the music piece that is being performed, more specifically, a part immediately after the part that is being performed can be visually understood may be generated as a return video. In such a case, the return video is supplied to each camera or a display device or the like corresponding to the camera in the live concert venue and is displayed.

Note that the return video may be the same video as the synthesized video presented to the audience or may be video that is different from the synthesized video. Also, the return video may differ for each camera.

Since the camera operators can clearly recognize at a glance which performer (member) should be filmed and at which timing by presenting such a return video, it is possible to reduce occurrence of a failure to capture a video, an imaging timing mistake, and an imaging mistake such as focus deviation.

Furthermore, the audience in the live concert venue and the viewers of the live video can easily visually recognize which performer is singing and which part is being sung by presenting the synthesized video that has been generated on the basis of the colored musical division data and displays lyrics with color information in the live concert venue.

### <Configuration Example of Information Processing Device>

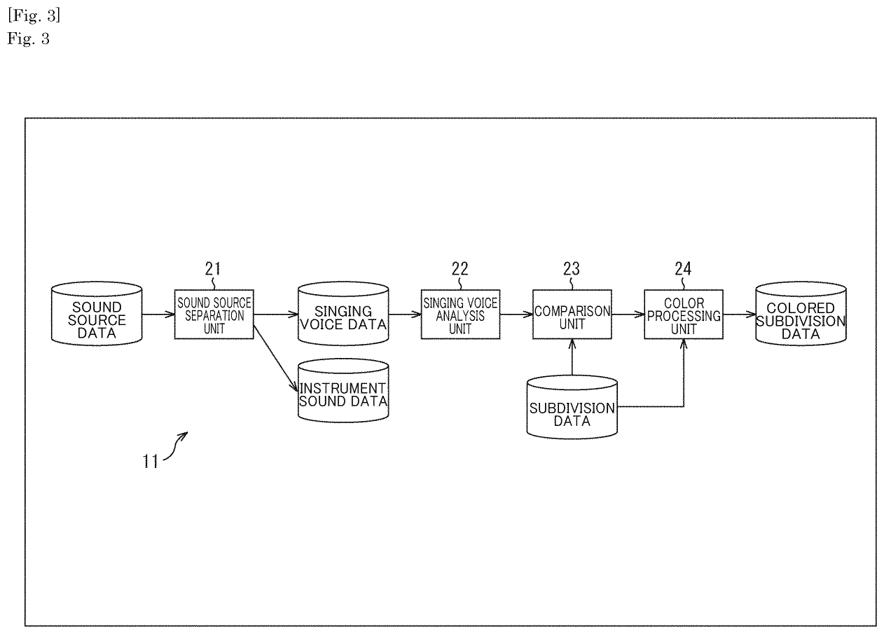

FIG. 3 is a diagram illustrating a configuration example of an information processing device configured of a computer or the like that performs the aforementioned prior processing. For example, an information processing device 11 illustrated in FIG. 3 may be installed in a video board or may be installed at a location that is different from the video board.

The information processing device 11 includes a sound source separation unit 21, a singing voice analysis unit 22, a comparison unit 23, and a color processing unit 24.

Sound source data that is audio data to replay sound of a music piece is supplied to the sound source separation unit 21. The sound source separation unit 21 separates instrument sound data and singing voice data from the sound source data by performing sound source separation processing on the supplied sound source data, and supplies the obtained singing voice data to the singing voice analysis unit 22.

Here, the singing voice data is audio data including sound of target sound sources (performers) that is singing voice of a performer, and the instrument sound data is audio data including other sound sources that are different from the performers, such as sound of instruments, that is, sound from sound sources other than the targets.

Note that in a case where there is singing voice data before remixing the instrument sound in advance, the sound source separation processing is not needed, and the sound source separation unit 21 may not be provided in such a case.

The singing voice analysis unit 22 performs singing voice analysis, that is, analysis processing on the singing voice data supplied from the sound source separation unit 21.

For example, which performer is singing and which section the performer is singing in the sound (singing voice) based on the singing voice data are specified in the singing voice analysis. In other words, a performer (sound source), sound (singing voice) of which is included in a section, is specified for each of a plurality of sections of the singing voice data.

In a specific example, it is possible to realize singing voice analysis by matching a frequency of the singing voice in the singing voice data with a frequency of voice of each performer prepared in advance, for example.

Also, the singing voice analysis unit 22 generates metadata of the music piece on the basis of voice analysis results (results of the singing voice analysis) for each section of the singing voice data. Furthermore, the singing voice analysis unit 22 generates temporary lyrics information by performing sound recognition processing on the singing voice data as singing voice analysis, for example.

The singing voice analysis unit 22 supplies the metadata of the music piece obtained through the singing voice analysis and the temporary lyrics information to the comparison unit 23.

For example, the singing voice analysis unit 22 performs transcription of the singing voice (sound) based on the singing voice data, that is text conversion of the singing voice data through the sound recognition processing and obtains character information (text information) indicating the results as lyrics information indicating the temporary lyrics of the music piece. The lyrics information is information indicating the temporary lyrics, and the lyrics indicated by the lyrics information is not necessarily accurate lyrics.

Moreover, the metadata of the music piece is data indicating which performer's voice is included in each section of the singing voice data. In other words, the metadata includes information indicating, for each of a plurality of sections of the singing voice data, a performer (sound source), the sound (singing voice) of which is included in the section. Note that in a case where the metadata is included in the sound source data of the music piece in advance, the metadata may be used.

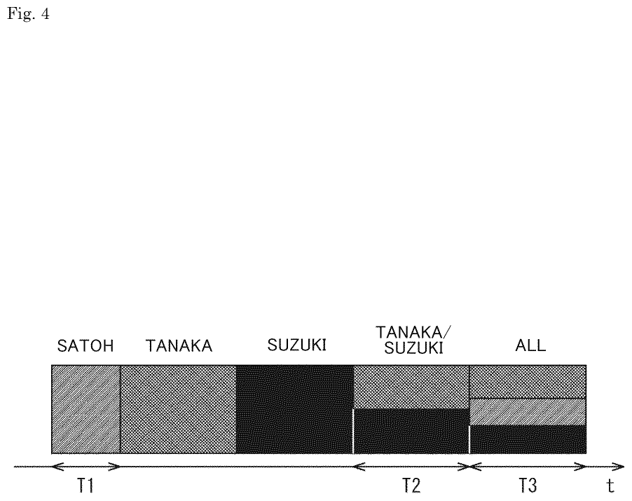

FIG. 4 illustrates an example of the metadata. In this example, the horizontal direction indicates time, and the metadata is time-line displayed in the drawing.

The metadata illustrated in FIG. 4 is a moving image data including information indicating each of a plurality of sections aligned in a time direction when the singing voice data is split into a plurality of time sections and information indicating a performer, the voice (sound) of which is included in each of the sections.

In particular, each of squares aligned in the time direction represents one section (time section), and color information indicating performers, the sound of which is included in the section, is added to each section in this example.

Specifically, one music piece is sung by three performers, “Satoh”, “Tanaka”, and “Suzuki”, and member colors of the performers “Satoh”, “Tanaka”, and “Suzuki” are defined as “green”, “blue”, and “orange” in this example.

If such metadata is replayed, a color representing a performer who is in charge of a part of the music piece corresponding to a time section is displayed for each replay time, that is, for each time section. Also, the name of the performer may be displayed with the color (color information) representing the performer.

Specifically, the color “green” representing the performer “Satoh” is presented in a section T1, for example. In other words, color information “green” indicating the performer “Satoh” has been added (applied) to the section T1.

Also, the colors “blue” and “orange” representing the performers “Tanaka” and “Suzuki” are presented in a section T2, and it is possible to ascertain that the part of the music piece corresponding to the section T2 is to be sung by the performers “Tanaka” and “Suzuki”.

In particular, a section in which a plurality and a smaller number of color information pieces than the total number of performers are displayed is a section called harmony in which the plurality of performers are in charge at the same time, and in the harmony section, a color representing the performer who is in charge of a part of a higher key is displayed at an upper part in the square representing the section. In other words, at the location of the harmony, a color information presentation region corresponding to each part is defined in advance for each part at the location.

In this example, it is possible to instantaneously visually recognize who is in charge of each part from the color “blue” displayed in the upper region and the color “orange” displayed in the lower region in the section T2, that is, a positional relationship of the regions. In other words, it is possible to intuitively recognize that the performer “Tanaka” corresponding to the color “blue” is in charge of the higher part while the performer “Suzuki” corresponding to the color “orange” is in charge of the lower part.

Also, the each of the colors “green”, “blue” and “orange” indicating each of all the performers “Satoh”, “Tanaka”, and “Suzuki” is presented in a section T3, and it is possible to ascertain that the part corresponding to the section T3 of the music piece is to be sung by all the performers.

Note that although the example in which the color information is added to each section has been described here, the metadata may be any information as long as it is possible to specify which performer's voice is included in each section of the singing voice data from the information. For example, an identifier such as a numerical value for identifying each performer or the name of the performer may be added to (displayed in) each section of the singing voice data in the metadata.

Returning to the explanation of FIG. 3, the comparison unit 23 compares the singing voice data with musical division data of the music piece prepared in advance.

In other words, more specifically, the comparison unit 23 compares the metadata of the music piece and the temporary lyrics information supplied from the singing voice analysis unit 22 with the musical division data prepared in advance and supplies comparison results and the metadata to the color processing unit 24.

In the comparison unit 23, the temporary lyrics information which is results of text conversion of the singing voice data and accurate lyrics indicated by the musical division data are compared, for example, to specify correspondence between each section in the singing voice data and each bar of the music piece in the musical divisions based on the musical division data. In other words, synchronization of the singing voice data and the musical division data is performed.

Also, the comparison unit 23 compares the correspondence between the performer indicated by the color information added to each section indicated by the metadata and the performer who is in charge of each bar in the musical divisions based on the musical division data. In the comparison between one of the temporary lyrics information and the metadata and the musical division data, comparison results between the other one and the musical division data may be appropriately referred to.

It is possible to improve accuracy of specification of each section (bar) of the music piece based on the singing voice data and specification of the performer who is in charge of each section of the music piece and to obtain more accurate colored musical division data by performing such comparison.

The color processing unit 24 generates colored musical division data on the basis of the metadata and the comparison results supplied from the comparison unit 23 and outputs the obtained colored musical division data to a recording medium or the like, which is not illustrated.

For example, the color processing unit 24 generates the colored musical division data by adding the color information to the lyrics information included in the musical division data prepared in advance for the sound source data of the music piece, that is, by applying colors to the lyrics on the basis of the metadata and the comparison results of the comparison unit 23. Note that the color processing unit 24 can generate accurate colored musical division data without using the musical division data if temporary lyrics information and metadata are corrected on the basis of the comparison result of the comparison unit 23.

### <Explanation of Colored Musical Division Data Generation Processing>

Next, operations of the information processing device 11 will be described.

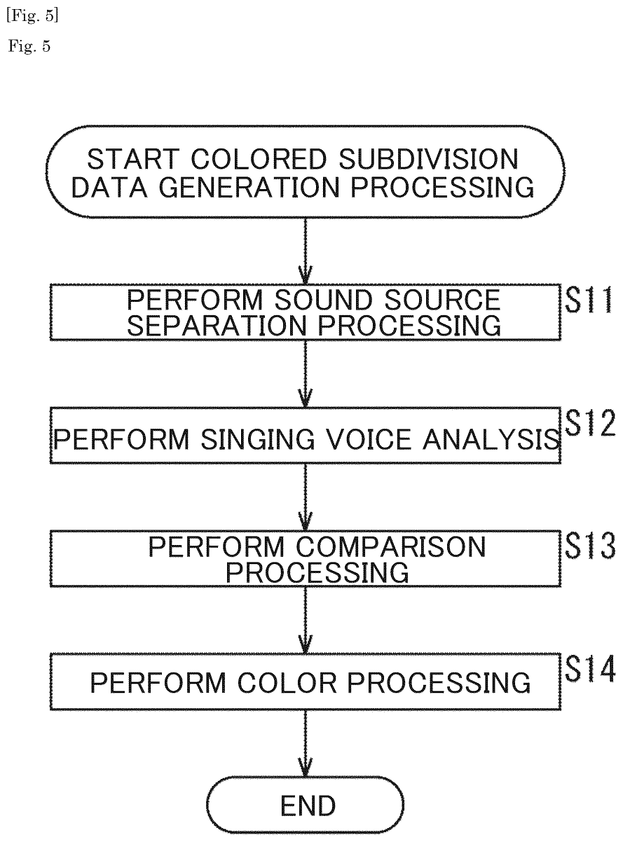

The information processing device 11 performs colored musical division data generation processing illustrated in FIG. 5 for each music piece performed in a live concert as the aforementioned prior processing at an appropriate timing before the live concert is started.

Hereinafter, the colored musical division data generation processing performed by the information processing device 11 will be described with reference to the flowchart in FIG. 5.

In Step S11, the sound source separation unit 21 performs sound source separation processing on supplied sound source data and supplies singing voice data obtained as a result to the singing voice analysis unit 22.

In Step S12, the singing voice analysis unit 22 performs singing voice analysis on the singing voice data supplied from the sound source separation unit 21 to generate temporary lyrics information and metadata and supplies the temporary lyrics information and the metadata to the comparison unit 23.

For example, metadata of the music piece is generated on the basis of results of the singing voice analysis, and temporary lyrics information is generated through sound recognition processing or the like on the basis of the singing voice data in Step S12. In this manner, the metadata illustrated in FIG. 4, for example, is obtained.

In Step S13, the comparison unit 23 performs comparison processing of comparing the metadata and the temporary lyrics information of the music piece supplied from the singing voice analysis unit 22 with musical division data prepared in advance and supplies the comparison results obtained through the comparison processing and the metadata to the color processing unit 24.

In Step S14, the color processing unit 24 generates colored musical division data by performing color processing on the basis of the metadata and the comparison results supplied from the comparison unit 23 and outputs the obtained colored musical division data.

For example, the results of the comparison processing (comparison results) are taken into consideration in the color processing, a start position, an end position, and the like of each section indicated by the metadata are appropriately corrected, and color information indicating performers who are in charge is added to the lyrics information in the musical division data, thereby obtaining colored musical division data.

Once the colored musical division data is obtained in this manner, the colored musical division data generation processing is ended.

As described above, the information processing device 11 generates colored musical division data by performing the singing voice analysis, the comparison processing, and the color processing on the basis of the lyrics data and the musical division data.

It is possible to enable the parts of the music piece that each performer is in charge of to be easily recognized through the obtained colored musical division data by generating the colored musical division data in this manner.

A set list, a length of each music piece, and the like for a live concert or the like are often determined several days before live rehearsal, and it is difficult to appropriately manually write them in musical division data for many music pieces. In this regard, it is possible to obtain appropriate colored musical division data in a short period of time without a need of manual efforts for many music pieces by using the present technology.

### <Configuration Example of Video Processing System>

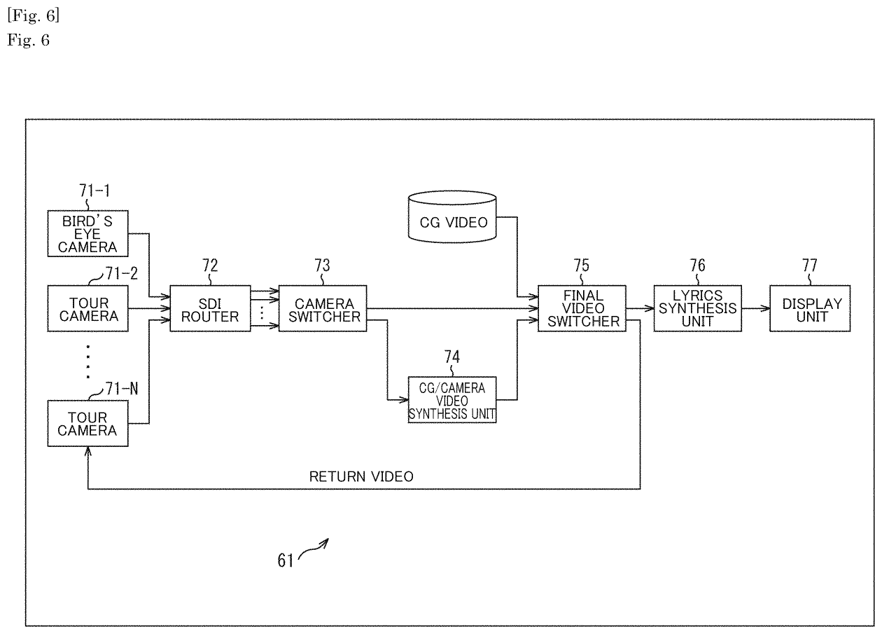

FIG. 6 is a diagram illustrating a configuration example of a video processing system that performs the aforementioned real-time processing.

A video processing system 61 illustrated in FIG. 6 includes a bird's eye camera 71-1, tour cameras 71-2 to 71-N, a serial digital interface (SDI) router 72, a camera switcher 73, a CG/camera video synthesis unit 74, a final video switcher 75, a lyrics synthesis unit 76, and a display unit 77.

The bird's eye camera 71-1 is a camera that is disposed at a position from which an entire live concert venue can be overlooked in the live concert venue, for example. The bird's eye camera 71-1 images the entire live concert venue as an object and supplies a camera video obtained as a result to the SDI router 72.

The tour cameras 71-2 to 71-N are arranged at fixed positions in the live concert venue, for example, or move inside of the venue with camera operators in the live concert venue.

The tour cameras 71-2 to 71-N image at least a part inside of the live concert venue as an object and supply camera videos obtained as a result to the SDI router 72.

Note that hereinafter, in a case where it is not necessary to particularly distinguish the tour cameras 71-2 to 71-N, the tour cameras 71-2 to 71-N will also be simply referred to as tour cameras 71.

In an example, although eight to ten tour cameras 71 are used to capture images in the live concert venue for example, the number of tour cameras 71 may be any number.

Also, in a case where it is not necessary to particularly distinguish the bird's eye camera 71-1 from the tour cameras 71, the bird's eye camera 71-1 and the tour cameras 71 will also be simply referred to as cameras 71 below. Hereinafter, it is assumed that at least one performer from among a plurality of performers who provide performance on a stage or the like is included as an object in the camera videos captured by the cameras 71.

The camera videos obtained by all the cameras 71 in the live concert venue are aggregated by the SDI router 72. The SDI router 72 supplies the camera video supplied from each of the plurality of cameras 71 to the camera switcher 73.

Note that connection between each camera 71 and the SDI router 72 may be established in a wired manner, may be established in a wireless manner, or may be established in combination of wired and wireless manners.

The camera switcher 73 supplies any one or a plurality of camera videos from among the plurality of camera videos supplied from the SDI router 72 to the CG/camera video synthesis unit 74 and supplies any one or a plurality of camera videos from among the plurality of camera videos supplied from the SDI router 72 to the final video switcher 75.

For example, the camera videos supplied to the CG/camera video synthesis unit 74 and the camera videos supplied to the final video switcher 75 are mutually different videos.

The CG/camera video synthesis unit 74 generates a synthesized video (hereinafter, also referred to as a synthetic camera video) by synthesizing other camera videos or CG videos prepared in advance with the camera videos supplied from the camera switcher 73 and supplies the synthesized video to the final video switcher 75.

The final video switcher 75 generates a synthesized video on the basis of at least any one of the camera videos supplied from the camera switcher 73, the synthetic camera video supplied from the CG/camera video synthesis unit 74, and the CG videos prepared in advance and supplies the synthesized video to the lyrics synthesis unit 76.

Also, the final video switcher 75 generates a return video on the basis of colored musical division data generated through the prior processing. At this time, the final video switcher 75 generates the return video appropriately using the camera videos supplied from the camera switcher 73, the synthetic camera video supplied from the CG/camera video synthesis unit 74 as well. As described above, the return video is a presentation video to be presented to the camera operators to check the image capturing timing and the like.

The final video switcher 75 supplies the generated return video to the cameras 71 or display devices such as SDI monitors or tablets disposed in the vicinity of camera operators who operate the cameras 71 and causes the cameras 71 or the display devices to display the return video.

Note that connection between each camera 71 or the display device corresponding to the camera 71 and the final video switcher 75 may be established in a wired manner, may be established in a wireless manner, or may be established in combination of wired and wireless manners.

The lyrics synthesis unit 76 superimposes colored lyrics information (colored text information), that is, lyrics with color information added thereto on the basis of the colored musical division data generated through the prior processing on the synthesized video supplied from the final video switcher 75, thereby obtaining a final synthesized video. The lyrics synthesis unit 76 supplies the final synthesized video to the display unit 77 and causes the display unit 77 to display the final synthesized video as a presentation video.

For example, the SDI router 72 to the lyrics synthesis unit 76 configuring the video processing system 61 are disposed in a video board.

The display unit 77 is configured of a display device such as an LED vision or a liquid crystal panel, for example, and is disposed on a stage or the like in a live concert venue. The LED vision is a large-sized display device configured of an LED panel. The display unit 77 presents the synthesized video to audience or the like of the live concert by displaying the synthesized video supplied from the lyrics synthesis unit 76.

### <Explanation of Display Processing>

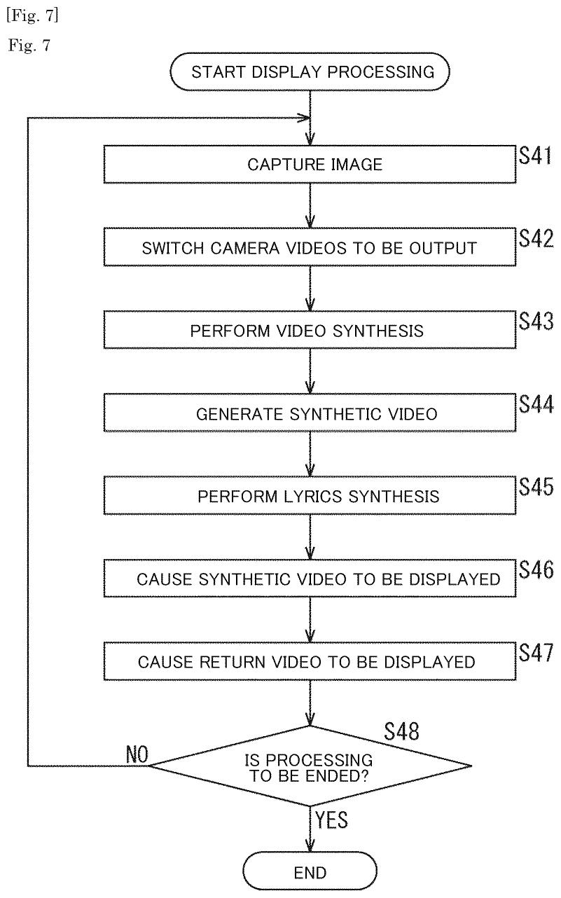

Subsequently, a rough flow of operations of the video processing system 61 will be described. In other words, display processing of the video processing system 61 will be described below with reference to the flowchart in FIG. 7. The display processing is performed as the aforementioned real-time processing.

In Step S41, each of the plurality of cameras 71 images a part or an entirety of the inside of the live concert venue as an object and supplies a camera video obtained as a result to the SDI router 72. Also, the SDI router 72 supplies the camera video supplied from each of the plurality of cameras 71 to the camera switcher 73.

In Step S42, the camera switcher 73 switches camera videos to be output to the CG/camera video synthesis unit 74 and the final video switcher 75.

For example, an operator or the like performs a switching operation of switching camera videos to be output to the CG/camera video synthesis unit 74 and the final video switcher 75 with reference to the colored musical division data and the presented camera videos and the like as needed. In other words, camera videos to be supplied to the CG/camera video synthesis unit 74 and camera videos to be supplied to the final video switcher 75 are selected.

Then, the camera switcher 73 supplies the designated camera videos from among the plurality of camera videos supplied from the SDI router 72 to the CG/camera video synthesis unit 74 in response to the switching operation performed by the operator or the like.

Similarly, the camera switcher 73 supplies the designated camera videos from among the plurality of camera videos supplied from the SDI router 72 to the final video switcher 75 in response to the switching operation performed by the operator or the like.

In Step S43, the CG/camera video synthesis unit 74 performs video synthesis on the basis of the camera videos supplied from the camera switcher 73.

For example, the CG/camera video synthesis unit 74 generates a synthetic camera video by synthesizing the camera videos supplied from the camera switcher 73 or synthesizing the camera videos supplied form the camera switcher 73 and CG videos and supplies the synthetic camera video to the final video switcher 75.

In Step S44, the final video switcher 75 generates the synthesized video and supplies the synthesized video the lyrics synthesis unit 76.

For example, the final video switcher 75 generates the synthesized video on the basis of at least any one of the camera videos supplied from the camera switchers 73, the synthetic camera video supplied from the CG/camera video synthesis unit 74, and the CG videos prepared in advance. At this time, the final video switcher 75 generates the synthesized video on the basis of an operation such as selection (switching) appropriately performed by the operator or the like and the colored musical division data prepared in advance.

Also, the final video switcher 75 generates a return video on the basis of the colored musical division data generated through the prior processing appropriately using the camera videos supplied from the camera switcher 73 and the synthetic camera video supplied from the CG/camera video synthesis unit 74 as well.

In Step S45, the lyrics synthesis unit 76 performs lyrics synthesis on the basis of the synthesized video supplied from the final video switcher 75 and the colored musical division data prepared in advance.

In other words, the lyrics synthesis unit 76 superimposes (synthesizes) the colored lyrics information based on the colored musical division data on the synthesized video from the final video switcher 75, thereby obtaining a final synthesized video.

In Step S46, the lyrics synthesis unit 76 supplies the final presentation synthesized video generated in Step S45 to the display unit 77 and causes the display unit 77 to display the synthesized video.

In Step S47, the final video switcher 75 supplies the generated return video to the cameras 71 or the display devices disposed in the vicinity of the camera operators who operate the cameras 71 and causes the cameras 71 or the display devices to display the return video.

In Step S48, the final video switcher 75 determines whether or not to end the processing of causing the synthesized video to be displayed.

In a case where it is determined that the processing is not to be ended yet in Step S48, then the processing returns to Step S41, and the aforementioned processing is repeatedly performed.

On the other hand, in a case where it is determined that the processing is to be ended in Step S48, each component of the video processing system 61 stops the processing that is being performed, and the display processing is ended.

As described above, the video processing system 61 generates the synthesized video and the return video using the colored musical division data and causes the synthesized video and the return video to be displayed.

In this manner, it is possible to cause the audience of the live concert to which the synthesized video is presented, the viewers of the live streaming, and the camera operators to which the return video is presented to easily recognize parts of the music piece that each performer is in charge of.

### <Configuration Example of Synthesized Video Generation Device>

Here, a more specific example of generation of a synthesized video will be described.

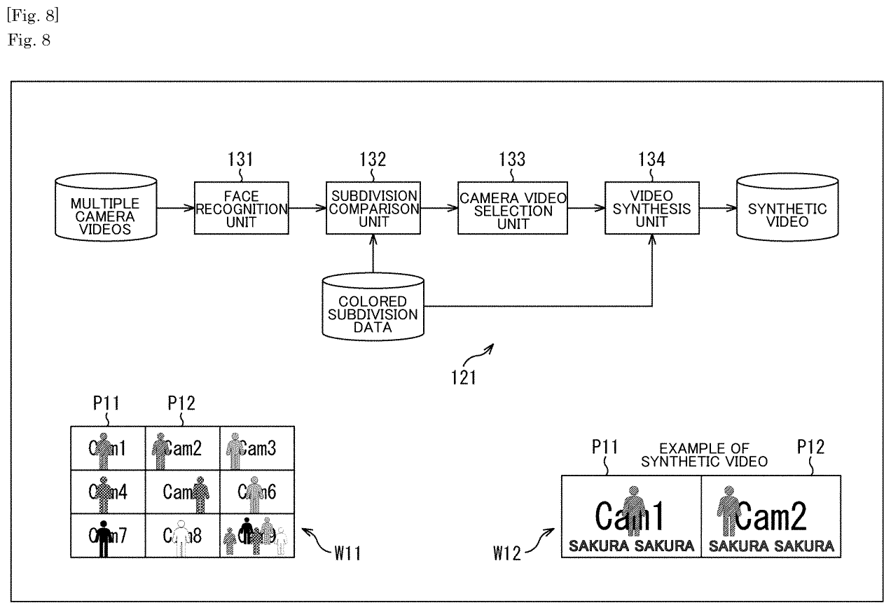

FIG. 8 is a diagram illustrating a configuration example of a synthesized video generation device that generates a final synthesized video to be displayed on the display unit 77.

A synthesized video generation device 121 illustrated in FIG. 8 is an information processing device including the camera switcher 73, the CG/camera video synthesis unit 74, the final video switcher 75, and the lyrics synthesis unit 76 illustrated in FIG. 6. Note that the synthesized video generation device 121 may be realized by one device or may be realized by a plurality of devices.

The synthesized video generation device 121 includes a face recognition unit 131, a musical division comparison unit 132, a camera video selection unit 133, and a video synthesis unit 134.

In particular, the camera video selection unit 133 is realized by the camera switcher 73 and functions as a candidate selection unit that selects candidates for camera videos to be used to generate a synthesized video that is a presentation video. Also, the video synthesis unit 134 is realized by the CG/camera video synthesis unit 74, the final video switcher 75, and the lyrics synthesis unit 76 and functions as a video generation unit that generates a presentation synthesized video.

A plurality of camera videos output from the SDI router 72 are supplied to the face recognition unit 131.

The face recognition unit 131 performs face recognition processing on the supplied camera videos, specifies performers (members) included as objects in the camera videos, and supplies the specification results as results of the face recognition processing to the musical division comparison unit 132. Also, the face recognition unit 131 also supplies the supplied plurality of camera videos to the musical division comparison unit 132.

Note that the face recognition unit 131 may perform the face recognition processing separately on each of the plurality of camera videos (video signals) or may perform the face recognition processing on one group video obtained by the camera switcher 73 merging the plurality of camera videos.

For example, the camera switcher 73 displays camera video arrays obtained by aligning a plurality of camera videos, such as 3×3 or 4×4 as indicated by the arrow W11.

In the example indicated by the arrow W11, three camera videos are aligned in each of the longitudinal direction and the lateral direction, and 3×3 (3 rows and 3 columns) camera video arrays including a total of nine camera videos are formed.

For example, a camera video P11 forming the camera video arrays has been captured by one camera 71, and one predetermined performer (member) is included as an object in the camera video P11. Similarly, a camera video P12 has been captured by another camera 71 that is different from the camera 71 that has captured the camera video P11, and the same performer as that in the case of the camera video P11 is also included as an object in the camera video P12.

For example, the camera switcher 73 may generate one group video by aligning and synthesizing the plurality of camera videos in the same arrays (arrangement) as those of the camera video arrays indicated by the arrow W11 and uses the group video as an input to the face recognition unit 131. In such a case, which performer is included as an object and which region in the group video, that is, which camera video configuring the group video the performer is included are specified in the face recognition processing.

For example, a plurality of feature points of a face of each performer prepared in advance may be compared with a plurality of feature points of a face extracted from the camera videos, and the face recognition processing may be performed on the basis of similarity of the feature points, more specifically, similarity of positional relationships of the feature points. In such a case, a score indicating similarity between the face included as an object in the camera videos and a predefined performer may also be output as a result of the face recognition processing.

In other cases where the camera 71 side has a face recognition function, for example, an artificial intelligence (AI) recognition function is mounted in the cameras 71, the cameras 71 may perform the face recognition processing. In such a case, results of the face recognition processing, for example, are added as metadata to the camera videos. The results of the face recognition processing can be performer information indicating performers (members) included as objects in the camera videos, for example.

The musical division comparison unit 132 compares the results of the face recognition processing supplied from the face recognition unit 131 with the colored musical division data prepared in advance and supplies the comparison results and the camera videos to the camera video selection unit 133.

In this case, a part of the colored musical division data that is being currently performed by the performers is supplied to the musical division comparison unit 132, for example. In other words, the musical division comparison unit 132 can specify the lyrics part that is being currently performed and the performers who are in charge of the lyrics part on the basis of the colored musical division data.

Similarly, the video synthesis unit 134 can also specify the lyrics part that is being currently performed and the performers who are in charge of the lyrics part on the basis of the colored musical division data.

For example, the musical division comparison unit 132 can specify the camera videos including, as objects, the performers (member) who are in charge of the part of the music piece that is being currently performed by comparing the results of the face recognition processing with the part (bar part) that is being currently performed in the colored musical division data. In other words, it is possible to specify whether or not the performers who are included as objects in the camera videos are currently emitting sound (singing).

The camera video selection unit 133 selects one or a plurality of camera videos as candidates for videos to be used to generate a final synthesized video (presentation synthesized video) from among the plurality of camera videos supplied from the musical division comparison unit 132 on the basis of the comparison results supplied from the musical division comparison unit 132.

For example, the camera video selection unit 133 selects, as candidates, the camera videos including at least the performers (members) who are in charge of the part of the music piece that is being performed, that is, the performers who are currently singing (sound sources of the sound that is being emitted) as objects.

In this case, since the same performers may be imaged as objects by a plurality of cameras 71, the number of the camera videos to be selected as the candidates may be one or more. For example, identification of the camera videos selected as the candidates may be performed on the basis of camera numbers for identifying the cameras 71 that have captured the camera videos, for example.

In other cases, camera videos as the candidates may be selected in response to a selecting operation performed by an operator or the like. In such a case, if scores indicating similarity with the performers have been obtained as results of the face recognition processing, for example, and the scores are displayed along with the camera videos, the operator or the like can select the camera videos as candidates with reference to the scores and the camera videos.

The camera video selection unit 133 supplies the one or a plurality of camera videos selected as the candidates to the video synthesis unit 134.

The video synthesis unit 134 generates a synthesized video on the basis of the at least one or more camera videos from among the one or plurality of camera videos supplied as the candidates from the camera video selection unit 133 and the colored musical division data prepared in advance and supplies the synthesized video to the display unit 77.

For example, the video synthesis unit 134 generates the synthesized video by aligning and synthesizing the plurality of camera videos supplied from the camera video selection unit 133 and super imposes the colored lyrics information on the synthesized video on the basis of the colored musical division data, thereby obtaining a final synthesized video.

Note that all the camera videos selected as the candidates by the camera video selection unit 133 may not necessarily be used to generate the synthesized video, and it is only necessary to use one or more camera videos from among the camera videos selected as the candidates to generate the synthesized video.

For example, one candidate (camera video) selected by the operator or the like from among the plurality of candidates may be used as it is as the synthesized video. In other cases, not only the camera videos selected from the candidates but also CG videos prepared in advance may be used to generate the synthesized video.

As a specific example of the synthesized video, in a case where the camera video arrays indicated by the arrow W11 are obtained, and the camera video P11 and the camera video P12 including the same performer as an object are selected as the candidates, for example, the synthesized video indicated by the arrow W12 is obtained.

In the synthesized video, the camera video P11 and the camera video P12 including the performer who is currently singing as an object are arranged in an aligned manner, and lyrics information of the part of the music piece that is being currently performed is superimposed with a color on the parts corresponding to the camera video P11 and the camera video P12.

In this example, in particular, the color of the lyrics information is a member color of the performer (member) included in the camera video P11 and the camera video P12, that is, the performer who is singing the part that is being performed.

In other words, the part that is being currently performed in the lyrics information described in the colored musical division data, that is, the part corresponding to the sound that is being emitted is displayed with the color representing the sound source (performer) of the sound that is being currently emitted in the synthesized video that is the presentation video.

The aforementioned processing performed by the face recognition unit 131 to the video synthesis unit 134 corresponds to the processing in Steps S42 to S45 in the display processing described with reference to FIG. 7.

Note that the video synthesis unit 134 may generate the return video for each camera 71 on the basis of the colored musical division data and supply the obtained return video to each camera 71 or the display device corresponding to the camera 71.

### <Description of Synthesized Video Generation Processing>

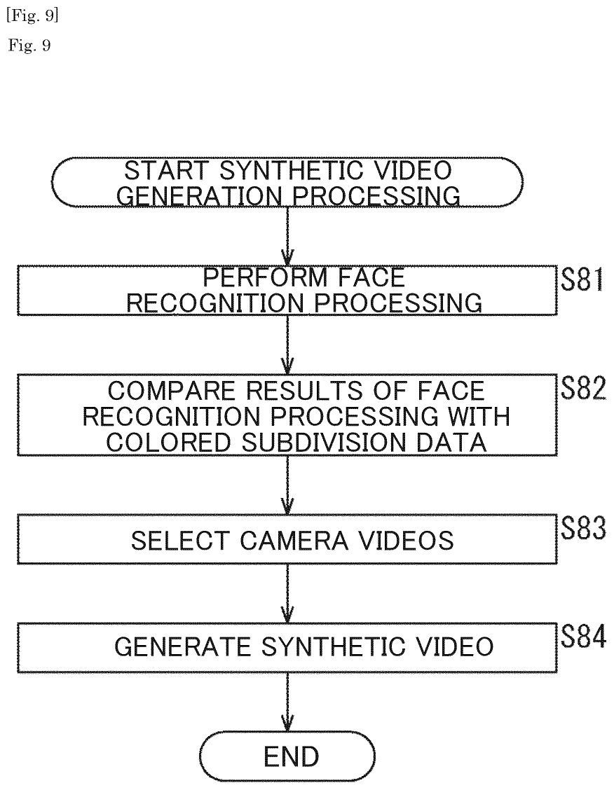

Subsequently, synthesized video generation processing performed by the synthesized video generation device 121 will be described with reference to the flowchart in FIG. 9. The synthesized video generation processing corresponds to Steps S42 to S45 in the display processing in FIG. 7.

In Step S81, the face recognition unit 131 performs the face recognition processing on the supplied camera videos and supplies results of the face recognition processing and the camera videos to the musical division comparison unit 132.

In Step S82, the musical division comparison unit 132 compares the results of the face recognition processing supplied from the face recognition unit 131 with the colored musical division data and supplies the comparison results and the camera videos supplied from the face recognition unit 131 to the camera video selection unit 133.

In Step S83, the camera video selection unit 133 selects candidates for camera videos to be used to generate a synthesized video from among the plurality of camera videos supplied from the musical division comparison unit 132 on the basis of the comparison results supplied from the musical division comparison unit 132. Then, the camera video selection unit 133 supplies the camera videos selected as the candidates to the video synthesis unit 134.

In Step S84, the video synthesis unit 134 generates the synthesized video on the basis of the camera videos supplied from the camera video selection unit 133 and the colored musical division data prepared in advance.

Also, the video synthesis unit 134 also appropriately generates a return video on the basis of the colored musical division data. In the return video, parts as presentation targets in the lyrics information described in the colored musical division data, arbitrary figures, character sequences (text) of names of the performers, and the like are displayed with colors representing sound sources of emitted sound, that is, the member colors of the performers.

Once the final synthesized video and the return video are generated, the synthesized video generation processing is ended.

The synthesized video generated in Step S84 is supplied to and displayed by the display unit 77 through the processing in Step S46 in FIG. 7, for example. Also, the return video generated in Step S84 is supplied to and displayed by the cameras 71 or the display devices corresponding to the cameras 71 through the processing in Step S47 in FIG. 7, for example.

As described above, the synthesized video generation device 121 generates the synthesized video on the basis of the camera videos and the colored musical division data.

In this case, if the synthesized video with the colored lyrics information superimposed thereon, for example, is generated, it is possible to allow the audience of the live concert and the viewers of the live streaming to which the synthesized video is presented to easily recognize parts of the music piece that each performer is in charge of.

Furthermore, it is possible to automatically generate the synthesized video in real time with the switching operation or the like of the operator or the like not always needed, by performing the face recognition processing and using the colored musical division data, for example.

Similarly, it is also possible to allow the camera operators to easily recognize the parts of the music piece that each performer is in charge of by generating the return video on the basis of the colored musical division data.

### <Example of User Interface>

Here, specific examples of the synthesized video and the return video described hitherto and a user interface (UI) and the like presented to the operator or the like in the camera switcher 73 and the final video switcher 75 will be described.

First, an example of a user interface presented by a display unit, which is not illustrated, to the operator or the like in the camera switcher 73 will be described.

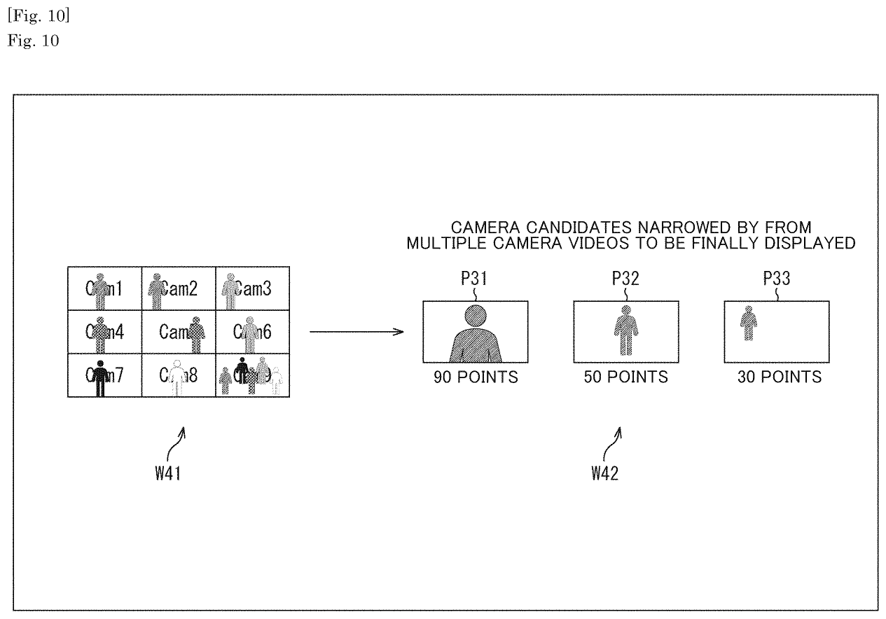

In the camera switcher 73, that is, in the synthesized video generation device 121, it is assumed that camera video arrays indicated by the arrow W41 in FIG. 10 are displayed on the display unit, which is not illustrated, for example. The camera video arrays indicated by the arrow W41 are similar to the camera video arrays indicated by the arrow W1i in FIG. 8.

Moreover, it is assumed that through the face recognition processing, the face recognition unit 131 has obtained scores such as a score of face recognition (a score of a likelihood of a performer) for each camera video and a score indicating an image angle of the camera video, that is, how good a composition is, for the camera videos on the basis of the results of the face recognition processing.

Specifically, a score of each camera video is obtained on the basis of a proportion of a region including face feature points with respect to a region of the entire image angle, that is, the size of the region of the face of the performer in the camera video, the number of feature points of the face extracted from the camera video, and the like.

At this time, the score of the composition or the like may be set to be low, for example, when face from the side of the performer is captured in the camera video since the number of feature points of the face extracted from the camera video decreases.

In this case, the video synthesis unit 134 may cause the display unit, which is not illustrated, more specifically, a UI displayed on the display unit to display each camera video selected by the camera video selection unit 133 as a candidate along with the score of the camera video as indicated by the arrow W42, for example.

In this example, the three camera videos P31 to P33 are displayed on the UI, and the score of each of the camera videos are displayed below the camera videos P31 and P33 in the drawing. In particular, the scores related to the compositions (image angles) of the camera videos are displayed here, and it is possible to ascertain that the score of the camera video P31 in which the face of the performer is captured in a large size is high.

Note that the score of each camera video may be the score related to the composition, for example, or may be a score indicating a level of similarity to the face of the performer in the face recognition, that is, a score indicating a likelihood of the performer, or scores of a plurality of items, such as both the scores, may be displayed.

The operator or the like performs the switching operation or the like with reference not only to the camera videos themselves displayed in this manner but also to the scores of the camera videos, and finally selects (designates) the camera videos to be displayed on the display unit 77, that is, the camera videos to be used to generate the synthesized video.

In a case where one or a plurality of camera videos have been designated through the switching operation or the like of the operator or the like, the synthesized video is generated on the camera videos designated by the switching operation or the like in Step S84 in FIG. 9, for example. In addition, a camera video designated by the switching operation may be used as it is as the synthesized video.

In other cases, the video synthesis unit 134 may select one or a plurality of camera videos in a descending order of the scores from among the plurality of camera videos selected as the candidates and use the camera videos to generate the synthesized video, without depending on the operation of the operator or the like.

The operator or the like can select more appropriate camera videos with reference to the scores as well and to cause the synthesized video to be generated through the presentation of the scores of the camera videos as described above.

For example, a plurality of performers may be captured in a camera video. If the scores of the face recognition, that is, the scores indicating the similarity to the performers are displayed in such a case, it is possible to easily and instantaneously specify whether the camera video is a camera video of the performer who is currently singing.

Note that the camera switcher 73 (camera video selection unit 133) instead of the video synthesis unit 134 may cause a display unit, which is not illustrated, to display each candidate (camera video) and the score as in the example illustrated in FIG. 10. In such a case, the camera switcher 73 selects a final camera video selected by the operator or the like from among the plurality of displayed candidates and supplies the selected camera video to the video synthesis unit 134.

### <Example of Return Video>

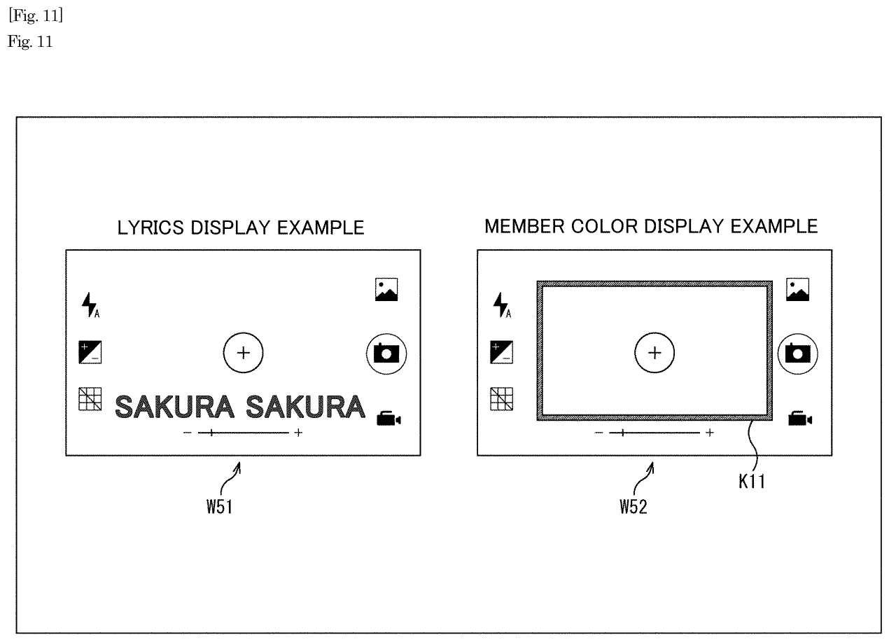

FIG. 11 illustrates an example of a return video displayed on a display unit of the camera 71.

In the example indicated by the arrow W51 in FIG. 11, for example, colored lyrics information as a return video is displayed in a superimposed manner on a through image including an object on a finder or a monitor as a display unit of the camera 71.

In particular, the lyrics information, that is, the character sequence (text) representing the lyrics is displayed with a member color of a performer (member) who is in charge of the part of the lyrics information and is displayed in accordance with the timing of the sound of the music piece that is being performed. In other words, a lyrics part of the music piece that is being currently performed, or a lyrics part to be performed immediately after the part of the music piece that is being currently performed is displayed with the member color.

Also, in the example indicated by the arrow W52, for example, a frame K11 surrounding the entire through image is displayed as a return video in the finder or the monitor as the display unit of the camera 71.

In particular, the frame K11 which is a colored figure as a return video is displayed with the member color of the performer (member) who is in charge of the part of the music piece that is being currently performed or the part to be performed immediately after the part of the music piece that is being currently performed. Also, once the performer (member) who is in charge of the corresponding part changes, the color of the frame displayed as the return video also changes.

In other words, information indicating the member color of the performer (member) who is in charge of the part of the music piece that is a target to be presented to the camera operators is displayed as the return video in accordance with the timing of the sound of the music piece that is being performed.

Note that the return video is not limited to the frame K11 and may be any other figure or may be colored text information (character sequence) or the like indicating the performer such as the name of the performer. The figure or the character sequence such as the name of the performer as the return video is displayed with the member color of the performer in such a case as well.

It is possible to ascertain which performer is to be imaged and which time the performer is to be imaged clearly at a glance by causing the return videos indicated by the arrow W51 and the arrow W52 to be displayed in accordance with the timing of the sound of the music piece. It is thus possible to reduce occurrence of a failure to capture a video, an imaging timing mistake, and an imaging mistake such as focus deviation.

Note that there may be a case where image capturing cannot be made in time even if information regarding the performer who is an imaging target is displayed as the return video in real time. Thus, it is possible to further reduce occurrence of imaging mistakes by generating, for the part immediately after the part of the music piece that is being currently performed, colored lyrics information of the part and the figure, the name of the performer, and the like with the member color of the performer who is in charge of the part as a return video separately for each camera 71.

In other cases, tally lights as lighting portions provided in the cameras 71 may be turned on (caused to emit light) by the video synthesis unit 134 supplying control signals to the cameras 71 on the basis of the colored musical division data. In this case, it is assumed that the video synthesis unit 134 has known which performer is to be imaged and which camera 71 to image the performer.

For example, a lighting portion called a tally light is provided at a part of each camera 71 that can be seen from the side of the object. In general, the tally light is used to check which camera is being used for image capturing for broadcasting. However, it is not possible to ascertain which performer is being imaged by the camera provided with the tally light from the side of the performers.

Thus, the video synthesis unit 134 may supply a control signal to the camera 71 that is imaging the performer who is in charge of the part of the music piece that is being currently performed as an object to cause the tally light of the camera 71 to be turned on with the member color of the performer who is in charge of the part that is being performed.

Thus, the performer can instantaneously recognize which camera 71 the performer himself/herself is to direct his/her line of sight, face, and the like, and it is possible to obtain a camera video with a better composition.

### <Example of Synthesized Video>

For example, a group shot video of a plurality of performers may be displayed as a synthesized video in a live concert venue. Also, each of a plurality of performers may be displayed as a synthesized video one by one in a time division manner.

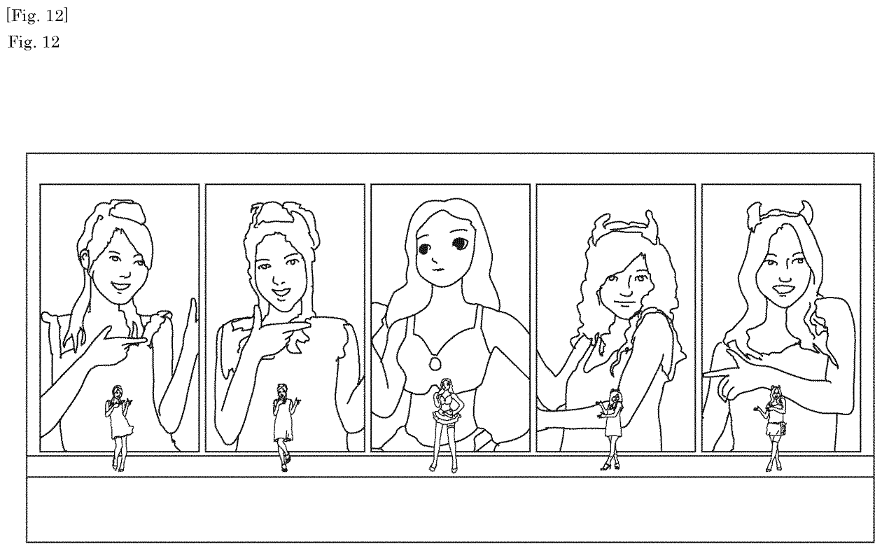

FIG. 12 illustrates an example of a case where a group shot video is displayed as a synthesized video.

In this example, five performers are performing on a stage, and a synthesized video is displayed behind the performers.

In particular, the synthesized video is divided into five member regions corresponding to the performers (members) in this example. Also, the synthesized video is displayed such that member regions where the performers are displayed in large sizes are arranged at parts behind the performers.

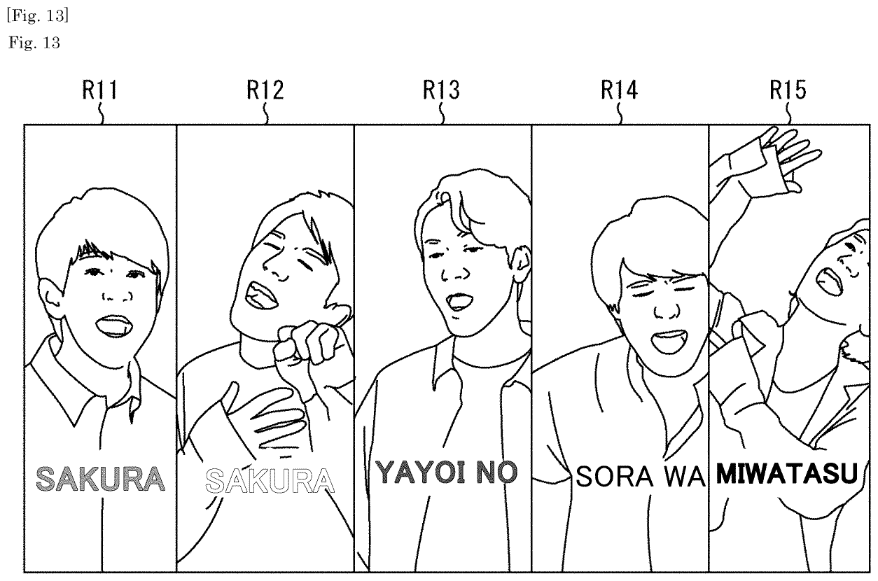

FIG. 13 illustrates another example of a case where a group shot video is displayed as a synthesized video.

In this example, the synthesized video is divided into member regions R11 to R15, the number of which is the same as the number of the performers, and a video of one performer (member) corresponding to each member region is displayed in the member region.

Specifically, a predetermined performer is displayed in the member region R11, and another performer is displayed in the member region R12, for example.

Also, lyrics information of the part of the music piece that is being performed is displayed with a color in the synthesized video, and in this example, the part of the lyrics information that is being displayed is a part that all the performers are to sing together.

At this time, it is possible to display each part of the lyrics information displayed in each member region with a member color of the performer corresponding to the member region. Specifically, the part of the lyrics information displayed in the member region R11 is displayed with a member color of the performer corresponding to the member region R11, for example.

In other cases, the part that all the members are to sing, that is, the part that all the performers are in charge of in the lyrics information may be displayed with gradation with member colors (all the member colors) of all the performers.

Such a synthesized video can be generated by crop-synthesizing the camera videos obtained by the plurality of cameras 71, for example.

It is possible to improve a realistic sensation of the video by dividing the entire screen of the synthesized video into the member regions and displaying the performers (members) in the respective member regions or by displaying the lyrics information with the colors in accordance with the member regions.

### Other Examples

With the colored musical division data as described above, it is possible to flexibly address an increase/decrease in number of performers, changes in colors corresponding to the performers, and the like. In other words, it is possible to change different color utilization in the musical divisions in an adaptable manner.

Even in a case where the member configuration in a group including a plurality of performers is changed, for example, it is possible to easily change the configuration of the performers and the colors representing the performers in the colored musical division data.

Moreover, although the example in which a color is associated with each performer has been described above, a color may be associated with a plurality of performers.

Specifically, in a case of an idol group including a large number of members, for example, different colors may be assigned to small groups including a plurality of performers, such as a blue color for first-season members, a green color for second-season members, a red color for third-season members, and a yellow color for fourth-season members, for example. It is still possible to change different color utilization in an adaptable manner in this case as well.

In other cases, a user may be able to designate arbitrary member colors in karaoke, for example. It is thus possible to change the different color utilization in accordance with user's preference.

In a specific example, different colors may be used depending on man's voice or woman's voice, for example. Moreover, it is also possible to reduce the number of colors from five to two, which is the number of users (the number of persons who sing a song) in a case where the two users sing a music piece of a five-member group, for example. In such a case, colored musical division data proposing realistic singing timing may be generated.

Furthermore, the present technology can also be applied to 3DCG lyrics generation and 3DCG effect generation using different colors for musical divisions, for example.

In general, lyrics display in live streaming is often 2D white letter display. Also, foreground/background extraction technologies using a green back, an infra-red (IR)/short wavelength infra-red (SWIR) camera, a depth camera, deep learning, and the like have been evolved.

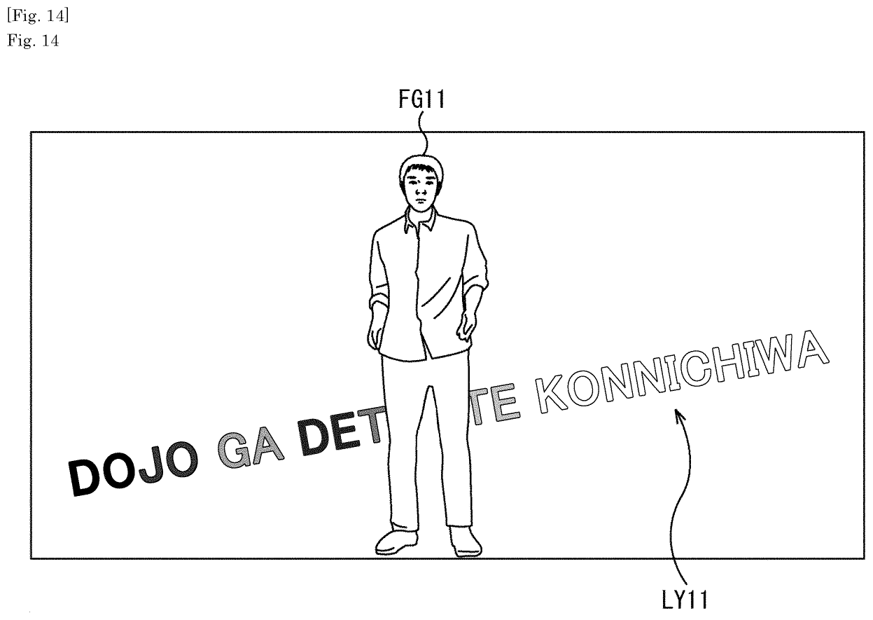

Thus, only a performer FG11 as a foreground may be extracted from a camera video as illustrated in FIG. 14, for example, the video of the performer FG11 may be synthesized with a background video such as a CG video, and colored lyrics information LY11 generated on the basis of colored musical division data may be synthesized with the background video, thereby obtaining a final synthesized video.

In this example, the video of the performer FG11 who is a person foreground extracted in real time is superimposed on (synthesized with) the background, and the lyrics information LY11 is also displayed as the background video with different colors applied on the basis of the colored musical division data. In particular, the display of the lyrics information LY11 is gradation display in which colors are different little by little in this example.

Note that not only the colors of the lyrics information but also the colors of effects such as particles and background videos may also be displayed with differently assigned colors on the basis of the colored musical division data.

As described above, it is possible not only to allow the video to be changed immediately before display but also to shorten a video creation time. Furthermore, it is possible to realize new video expressions.

Furthermore, the present technology can be applied not only to a live concert but also to captions for stage performance and TV programs, various video distribution services, subtitles for movies, and the like.

For example, it is possible to show lines of a stage performance for each performer, for each sex, or for each small group with different colors by generating data similar to the colored musical division data. Similarly, it is possible to show TV captions with a different color for each cast.

In recent years, each broadcasting station has made a variety of efforts for broadcasting for hearing-impaired people, teletext broadcasting, and the like, and the present technology that can be applied to TV broadcasting and the like is useful.

Also, in a case where the present technology is applied to subtitles of a movie, for example, it is only necessary to perform sound recognition processing on sound data of movie content and to show lines with different colors in accordance with characters through audio letters or translation.

The present technology also enables different color utilization without any prior processing as long as it is possible to perform simultaneous real-time processing of the sound recognition processing and the face recognition processing.

### <Example of Configuration of Computer>

The above-described series of processing can also be performed by hardware or software. In the case where the series of processes is executed by software, a program that configures the software is installed on a computer. Here, the computer includes, for example, a computer built in dedicated hardware, a general-purpose personal computer on which various programs are installed to be able to execute various functions, and the like.

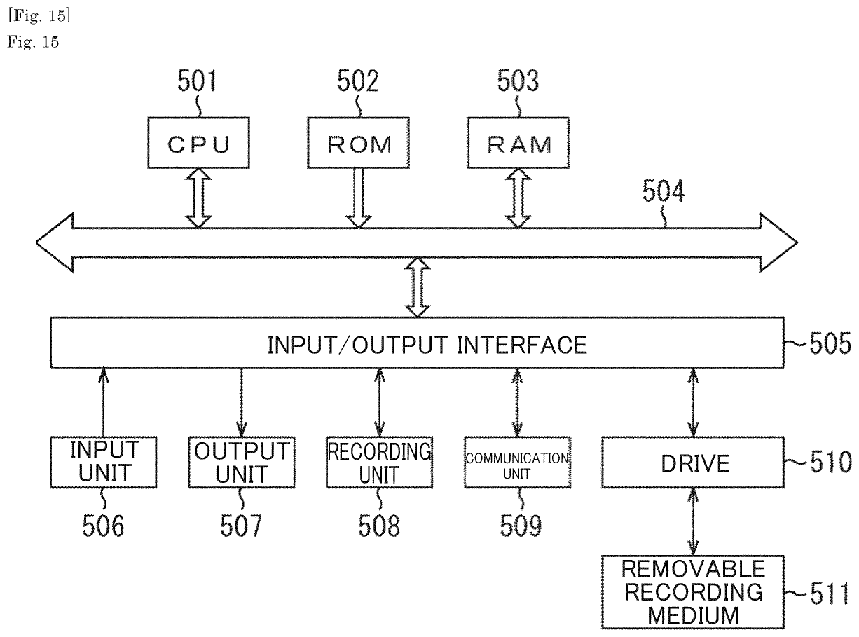

FIG. 15 is a block diagram illustrating a configuration example of computer hardware that executes the aforementioned series of processing using a program.

In the computer, a central processing unit (CPU) 501, read-only memory (ROM) 502, and random access memory (RAM) 503 are connected to one another via a bus 504.

An input/output interface 505 is further connected to the bus 504. An input unit 506, an output unit 507, a recording unit 508, a communication unit 509, and a drive 510 are connected to the input/output interface 505.

The input unit 506 is a keyboard, a mouse, a microphone, an imaging element, or the like. The output unit 507 is a display, a speaker, or the like. The recording unit 508 includes a hard disk and a nonvolatile memory. The communication unit 509 includes a network interface. The drive 510 drives a removable recording medium 511 such as a magnetic disk, an optical disc, a magneto-optical disk, or a semiconductor memory.

In the computer configured thus, the CPU 501 loads, for example, a program recorded in the recording unit 508 into the RAM 503 through the input/output interface 505 and the bus 504 and executes the program, so that the series of processing is performed.

The program executed by the computer (the CPU 501) can be recorded on, for example, the removable recording medium 511 serving as a package medium for supply. The program can also be provided through a wired or wireless transmission medium such as a local area network, the Internet, or digital satellite broadcasting.

In the computer, by mounting the removable recording medium 511 on the drive 510, it is possible to install the program in the recording unit 508 via the input/output interface 505. Furthermore, the program can be received by the communication unit 509 through a wired or wireless transfer medium and installed on the recording unit 508. In addition, the program can be installed in advance on the ROM 502 or the recording unit 508.

Meanwhile, the program executed by the computer may be a program through which processes are performed in a time series according to sequences described in the present description or a program through which processes are performed in parallel or at a necessary timing such as a timing at which calling is performed.

Furthermore, embodiments of the present technology are not limited to the above-described embodiments and can be modified in various manners within the scope of the present technology without departing from the gist of the present technology.

For example, the present technology can be configured as cloud computing in which one function is shared and processed in common by a plurality of devices via a network.

Each step described in the above-described flowcharts can be performed by a single device and can also be shared and performed by a plurality of devices.

Further, when one step includes a plurality of steps of processing, the plurality of steps of processing included in the one step can be performed by a single device and can also be shared and performed by a plurality of devices.

Furthermore, the present technology can be configured as follows.

(1)

An information processing device including: a video generation unit that generates, on the basis of text information including text of sound from a plurality of sound sources and one or a plurality of videos including the at least one sound source as an object, a presentation video in which with a color representing the sound source of sound that is being emitted, a part of the text corresponding to the sound that is being emitted, a figure, or a character sequence representing the sound source is displayed.

(2)

The information processing device according to (1), in which the text information is colored text information in which a different color for each of the sound sources is added to the text of sound from each of the plurality of sound sources.

(3)

The information processing device according to (1) or (2), in which in the presentation video, at least the sound source of sound that is being emitted is displayed as the object from among the plurality of sound sources.

(4)

The information processing device according to any one of (1) to (3), further including: a face recognition unit that performs face recognition processing on the plurality of videos,
in which the video generation unit generates the presentation video on the basis of a result of the face recognition processing and the text information.
   (5)

The information processing device according to (4), further including: a candidate selection unit that selects candidates for the videos to be used to generate the presentation video from among the plurality of videos on the basis of the result of the face recognition processing and the text information, the video generation unit generating the presentation video on the basis of one or more videos from among the one or the plurality of videos selected as the candidates.

(6)

The information processing device according to (5), in which the video generation unit causes the one or the plurality of videos selected as the candidates to be displayed along with scores obtained for the videos on the basis of the results of the face recognition processing.

(7)

The information processing device according to (6), in which the scores are scores of likelihoods of the sound sources or scores of compositions of the videos.

(8)

The information processing device according to (6) or (7), in which the video generation unit generates the presentation video on the basis of the one or the plurality of videos selected by an operator from among the one or the plurality of videos presented as the candidates along with the scores.

(9)

The information processing device according to any one of (5) to (8), in which the candidate selection unit selects, as the candidates, the videos including the sound sources of sound that is being emitted as objects.

(10)

The information processing device according to (2), in which the presentation video is generated for each camera that capturing the video including the sound source as the object and is supplied to the camera or a display device corresponding to the camera.

(11)

The information processing device according to (10), in which the video generation unit generates the presentation video in which with a color representing the sound source of sound emitted immediately after sound that is being currently emitted, a part of the text corresponding to the sound emitted immediately after, the figure, or the character sequence is displayed, and supplies the presentation video to the camera or the display device.

(12)

The information processing device according to (2), in which the video generation unit causes a lighting portion of a camera that images the sound source of sound that is being currently emitted as an object to emit light with a color representing the sound source of the sound that is being currently emitted on the basis of the colored text information.

(13)

The information processing device according to (2), in which the colored text information is colored musical division data of a music piece.

(14)

An information processing method including, using an information processing: generating, on the basis of text information including text of sound from a plurality of sound sources and one or a plurality of videos including the at least one sound source as an object, a presentation video in which with a color representing the sound source of sound that is being emitted, a part of the text corresponding to the sound that is being emitted, a figure, or a character sequence representing the sound source is displayed.

(15)

A program that causes a computer to execute processing including: generating, on the basis of text information including text of sound from a plurality of sound sources and one or a plurality of videos including the at least one sound source as an object, a presentation video in which with a color representing the sound source of sound that is being emitted, a part of the text corresponding to the sound that is being emitted, a figure, or a character sequence representing the sound source is displayed.

(16)

An information processing device including: a color processing unit that generates, on the basis of audio data including sound from a plurality of sound sources, or metadata of the audio data, and text information including text of the sound from the plurality of sound sources prepared in advance in regard to the audio data, colored text information in which a different color for each of the sound sources is added to the text of the sound from each of the plurality of sound sources.

(17)

The information processing device according to claim (16), further including: a sound source generation unit that performs sound source separation processing on sound source data including the sound from the plurality of sound sources and sound of other sound sources that are different from the plurality of sound sources, in which the color processing unit generates the colored text information on the basis of the audio data of the sound from the plurality of sound sources and the text information obtained through the sound source separation processing.

(18)

The information processing device according to (16) or (17), further including: an analysis unit that performs analysis processing of specifying, for each of a plurality of sections of the audio data, the sound sources, sound from which is included in the section,
in which the color processing unit generates the colored text information on the basis of results of the analysis processing and the text information.
   (19)

The information processing device according to any one of (16) to (18), further including: an analysis unit that performs analyzing processing of text conversion of the audio data,
in which the color processing unit generates the colored text information on the basis of results of the text conversion and the text information.
   (20)

The information processing device according to (16), in which the metadata includes information indicating, for each of a plurality of sections of the audio data, the sound source, sound from which is included in the section.

(21)

The information processing device according to any one of (16) to (20), in which the colored text information is colored musical division data of a music piece.

(22)

An information processing method causing an information processing device to: generate, on the basis of audio data including sound from a plurality of sound sources, or metadata of the audio data, and text information including text of the sound from the plurality of sound sources prepared in advance in regard to the audio data, colored text information in which a different color for each of the sound sources is added to the text of the sound from each of the plurality of sound sources.

(23)

A program that causes a computer to execute processing including: generating, on the basis of audio data including sound from a plurality of sound sources, or metadata of the audio data, and text information including text of the sound from the plurality of sound sources prepared in advance in regard to the audio data, colored text information in which a different color for each of the sound sources is added to the text of the sound from each of the plurality of sound sources.

Reference Signs List

| | |
|---|---|
| 11 | Information processing device |
| 21 | Sound source separation unit |
| 22 | Singing voice analysis unit |
| 23 | Comparison unit |
| 24 | Color processing unit |
| 61 | Video processing system |
| 73 | Camera switcher |
| 75 | Final video switcher |
| 76 | Lyrics synthesis unit |
| 121 | Synthesized video generation device |
| 131 | Face recognition unit |
| 132 | Musical division comparison unit |
| 133 | Camera video selection unit |
| 134 | Video synthesis unit |

1. An information processing device comprising:
a video generation unit that generates, on the basis of text information including text of sound from a plurality of sound sources and one or a plurality of videos including the at least one sound source as an object, a presentation video in which with a color representing the sound source of sound that is being emitted, a part of the text corresponding to the sound that is being emitted, a figure, or a character sequence representing the sound source is displayed.

2. The information processing device according to claim 1, wherein the text information is colored text information in which a different color for each of the sound sources is added to the text of sound from each of the plurality of sound sources.

3. The information processing device according to claim 1, wherein in the presentation video, at least the sound source of sound that is being emitted is displayed as the object from among the plurality of sound sources.

4. The information processing device according to claim 1, further comprising:
a face recognition unit that performs face recognition processing on the plurality of videos, wherein the video generation unit generates the presentation video on the basis of a result of the face recognition processing and the text information.

5. The information processing device according to claim 4, further comprising:
a candidate selection unit that selects candidates for the videos to be used to generate the presentation video from among the plurality of videos on the basis of the result of the face recognition processing and the text information, the video generation unit generating the presentation video on the basis of the one or more videos from among the one or the plurality of videos selected as the candidates.

6. The information processing device according to claim 5, wherein the video generation unit causes the one or the plurality of videos selected as the candidates to be displayed along with scores obtained for the videos on the basis of the results of the face recognition processing.

7. The information processing device according to claim 6, wherein the scores are scores of likelihoods of the sound sources or scores of compositions of the videos.

8. The information processing device according to claim 6, wherein the video generation unit generates the presentation video on the basis of the one or the plurality of videos selected by an operator from among the one or the plurality of videos presented as the candidates along with the scores.

9. The information processing device according to claim 5, wherein the candidate selection unit selects, as the candidates, the videos including the sound sources of sound that is being emitted as objects.

10. The information processing device according to claim 2, wherein the presentation video is generated for each camera that has captured the video including the sound source as the object and is supplied to the camera or a display device corresponding to the camera.

11. The information processing device according to claim 10, wherein the video generation unit generates the presentation video in which with a color representing the sound source of sound emitted immediately after sound that is being currently emitted, a part of the text corresponding to the sound emitted immediately after, the figure, or the character sequence is displayed, and supplies the presentation video to the camera or the display device.

12. The information processing device according to claim 2, wherein the video generation unit causes a lighting portion of a camera that images the sound source of sound that is being currently emitted as an object to emit light with a color representing the sound source of the sound that is being currently emitted on the basis of the colored text information.

13. The information processing device according to claim 2, wherein the colored text information is colored musical division data of a music piece.

14. An information processing method, using an information processing device, comprising:
generating, on the basis of text information including text of sound from a plurality of sound sources and one or a plurality of videos including the at least one sound source as an object, a presentation video in which with a color representing the sound source of sound that is being emitted, a part of the text corresponding to the sound that is being emitted, a figure, or a character sequence representing the sound source is displayed.

15. A program that causes a computer to execute processing including:
generating, on the basis of text information including text of sound from a plurality of sound sources and one or a plurality of videos including the at least one sound source as an object, a presentation video in which with a color representing the sound source of sound that is being emitted, a part of the text corresponding to the sound that is being emitted, a figure, or a character sequence representing the sound source is displayed.

16. An information processing device comprising:
a color processing unit that generates, on the basis of audio data including sound from a plurality of sound sources, or metadata of the audio data, and text information including text of the sound from the plurality of sound sources prepared in advance in regard to the audio data, colored text information in which a different color for each of the sound sources is added to the text of the sound from each of the plurality of sound sources.

17. The information processing device according to claim 16, further comprising:
an analysis unit that performs analysis processing of specifying, for each of a plurality of sections of the audio data, the sound sources, sound from which is included in the section, wherein the color processing unit generates the colored text information on the basis of results of the analysis processing and the text information.

18. The information processing device according to claim 16, wherein the colored text information is colored musical division data of a music piece.

19. An information processing method, using an information processing device, comprising:
generating, on the basis of audio data including sound from a plurality of sound sources, or metadata of the audio data, and text information including text of the sound from the plurality of sound sources prepared in advance in regard to the audio data, colored text information in which a different color for each of the sound sources is added to the text of the sound from each of the plurality of sound sources.

20. A program that causes a computer to execute processing including:
generating, on the basis of audio data including sound from a plurality of sound sources, or metadata of the audio data, and text information including text of the sound from the plurality of sound sources prepared in advance in regard to the audio data, colored text information in which a different color for each of the sound sources is added to the text of the sound from each of the plurality of sound sources.
